(19) United States
(12) Patent Application Publication
(10) Pub. No.: US 2001/0006917 A1
(43) Pub. Date: Jul. 5, 2001

(54) Relief valve built-in hydraulic tensioner

(76) Inventor: Hiroshi Hashimoto, Osaka (JP)

Correspondence Address: DANN DORFMAN HERRELL & SKILLMAN, SUITE 720, 1601 MARKET STREET, PHILADELPHIA, PA, 19103-2307, US

(21) Appl. No.: 09/749,094

(22) Filed: Dec. 27, 2000

(30) Foreign Application Priority Data
Dec. 27, 1999 (JP) 370449/1999

(51) Int. Cl. F16H 7/08; F16H 7/22

(52) U.S. Cl. 474/110; 474/109; 474/138

(57) ABSTRACT

A hydraulic tensioner includes a build-in relief valve having a relief hole formed in a housing of the tensioner, a ring-shaped valve element disposed in the housing at a side opposite to the front end of a plunger slidably mounted on the housing, and a spring urging the valve element in a direction to close the relief hole. The valve element and the spring of the relief valve are disposed coaxially with the plunger and a check valve provided between the housing and an oil chamber defined between the housing and the plunger. With this arrangement, the housing is made compact in size and hence enables downsizing of the tensioner. The relief valve disposed interiorly of the housing is highly reliable in operation.

### BACKGROUND OF THE INVENTION

1. Field of the Invention

The present invention relates to a hydraulic tensioner with built-in relief valve (hereinafter referred to as “relief valve built-in hydraulic tensioner) used to apply an appropriate tension to a timing chain of an automobile engine.

2. Related Art

Hydraulic tensioners used to apply an appropriate tension to a timing chain of an automobile engine include a hydraulic tensioner having a built-in relief valve that, when there occurs an excessive tension in the timing chain, relieves the excessive tension.

FIG. 5 is a front sectional view illustrating one example of the conventional relief valve built-in hydraulic tensioner. As shown in this figure, the conventional relief valve built-in hydraulic tensioner 1 includes a housing 2, a plunger 3 slidably fitted in a blind hole 2A formed in the housing 2, a spring 4 that urges the plunger 3 in a direction projecting outward from the blind hole 2A, an oil chamber 5 formed between the housing 2 and the plunger 3, a check valve 6 provided on the bottom of the blind hole 2A in the housing 2, and a relief valve 7 provided in the housing 2 at position located radial outward of the check valve 6.

The check valve 6 includes a ball seat 6B having an oil path 6A and press-fitted in a hole 2B formed in the bottom of the blind hole 2A in the housing 2, a check ball 6C, a retainer 6D, and a spring 6E. The hole 2B formed in the housing 2 is connected with an oil path (not shown) formed for supplying an oil into the oil chamber 5 from a hydraulic pressure generator or source such as an oil pump (not shown). The check valve 6 has a function that permits an oil to flow into the chamber 5 and in reverse blocks an oil to flow out from the oil chamber 5.

The relief valve 7 includes a valve element insertion hole 7A formed in the housing 2, a connecting hole 7B that communicates the oil chamber 5 with the valve element insertion hole 7A, a valve element 7C slidably received in the valve element insertion hole 7A, a spring 7D urging the valve element 7C, a relief hole 7E that communicates the valve element insertion hole 7A in the housing 2 with the outside air, and a plug 7G press-fitted in the the valve element insertion hole 7A and having a central hole 7F communicating the valve element insertion hole 7A with the outside air. With the relief valve 7 thus constructed, when the oil pressure inside the oil chamber 5 exceeds a set pressure, the valve element 7C moves backward against the force of the spring 7D to such an extent that the connecting hole 7B communicates with the relief hole 7E to thereby relieve the oil pressure inside the oil chamber 5.

When a looseness occurs in the chain during the engine being in driving, the plunger moves forward by the fore of the spring 4, and at the same time, the check ball 6C moves out off the ball seat 6B whereupon the oil is supplied into the oil chamber 5 by way of the oil path (not shown) formed in the housing 2 and the oil path 6A formed in the ball seat 6B. Thus, the tension in the chain is maintained.

When an excessive tension occurs in the chain, the plunger 3 receives a pressing load in the reverse urging direction from a tensioner lever not shown. At this moment, the check valve 6 functions to block the flow-out of an oil in the oil chamber 5, and the oil in the oil chamber 5 being an incompressible fluid deters the plunger 3 from returning. However, receiving an oil pressure generated in the oil chamber 5, the valve element 7C of the relief valve 7 slightly slide backward against the force of the spring 7D. Thus, the excessive tension occurred in the chain is absorbed. When the pressing load on the plunger 3 increases further and the valve element 7C of the relief valve 7 retreats further, the connecting hole 7B communicates with the relief hole 7E, which permits the oil in the oil chamber 5 to discharge, thereby reducing the oil pressure in the oil chamber 5. Thus, the excessive tension in the chain is relieved. As the oil pressure in the oil chamber 5 decreases accompanied with the discharge of the oil, the valve element 7C urged by the spring 7D closes the relief hole 7E, thus maintaining the set value of the oil pressure in the oil chamber 5. Further, as the oil pressure in the oil chamber 5 decreases excessively, the check valve 6 functions to flow an oil into the oil chamber 5, whereby the oil pressure in the oil chamber 5 returns to a normal value.

FIG. 6 is a front sectional view illustrating another example of the conventional relief valve built-in hydraulic tensioner. As shown in this figure, the conventional relief valve built-in hydraulic tensioner 11 includes a housing 12, a plunger 13 slidably fitted in a blind hole 12A formed in the housing 12, a spring 14 that urges the plunger 13 in a direction to project from the blind hole 12A, an oil chamber 15 formed between the housing 12 and the plunger 13, a check valve 16 provided on the bottom of the blind hole 12A in the housing 12, and a relief valve 17 provided on a front end of the plunger 13.

The check valve 16 includes a ball seat 16B having an oil path 16A and press-fitted in a hole 12B formed in the bottom of the blind hole 12A formed in the housing 12, a check ball 16C, a retainer 16D, and a spring 16E. The hole 12B formed in the housing 12 is connected with an oil path (not shown) which is used to supply an oil into the oil chamber 15 from a hydraulic pressure generator or source such as an oil pump (not shown). The check valve 16 has a function that permits an oil to flow into the chamber 15 and in reverse blocks an oil to flow out from the oil chamber 15.

The relief valve 17 includes a valve element insertion hole 17A formed in the front end of the plunger 13, a connecting hole 17B that communicates the oil chamber 15 with the valve element insertion hole 17A, a valve element 17C slidably received in the valve element insertion hole 17A, a spring 17D that urges the valve element 17C, a relief hole 17E that communicates the valve element insertion hole 17A formed in the plunger 13 with the outside air, and a plug 17G press-fitted in the valve element insertion hole 17A and having a central hole 17F communicating the valve element insertion hole 17A with the outside air. When the oil pressure inside the oil chamber 15 exceeds a set pressure, the valve element 17C moves backward against the force of the spring 17D, and the connecting hole 17B communicates with the relief hole 17E; thus the relief valve 17 displays a function to reduce the oil pressure inside the oil chamber 15.

The relief valve built-in hydraulic tensioner 11 maintains the tension of the chain in such a manner that, when a looseness occurs in the chain during the engine being in driving, the plunger 13 moves forward by the force of the spring 14, and at the same time, the check ball 16C moves out off the ball seat 16B to thereby permit an oil to be supplied into the oil chamber 15 by way of the oil path (not illustrated) formed in the housing 12 and the oil path 16A formed in the ball seat 16B.

When an excessive tension occurs in the chain, the plunger 13 receives a pressing load in the reverse urging direction from a tensioner lever not illustrated. At this moment, the check valve 16 functions to block the flow-out of an oil in the oil chamber 15, and the oil in the oil chamber 15 being an incompressible fluid deters the plunger 13 from returning. However, receiving an oil pressure generated in the oil chamber 15, the valve element 17C of the relief valve 17 slightly slide backward against the energizing force of the spring 17D. Thus, the relief valve built-in hydraulic tensioner 11 absorbs the excessive tension that occurred in the chain. When the pressing load to the plunger 13 increases further and the valve element 17C of the relief valve 17 retreats further, the connection hole 17B communicates with the relief hole 17E, which permits the oil in the oil chamber 15 to discharge, thereby reducing the oil pressure in the oil chamber 15 to relieves the excessive tension of the chain. As the oil pressure in the oil chamber 15 decreases accompanied with the discharge of the oil, the valve element 17C urged by the spring 17D moves to close the relief hole 17E, thus maintaining the set value of the oil pressure in the oil chamber 15. Further, when the oil pressure in the oil chamber 15 decreases excessively, the check valve 16 functions to flow an oil into the oil chamber 15, whereby the oil pressure in the oil chamber 15 returns to a normal value.

However, in the conventional relief valve built-in hydraulic tensioner 1 as shown in FIG. 5, since the relief valve 7 is provided on the radial outside of the check valve 6 in the housing 2, the housing 2 has to be made larger, and the tensioner 1 as a whole cannot be made compact.

Further, in the conventional relief valve built-in hydraulic tensioner 11 as shown in FIG. 6, since the relief valve 17 is incorporated in the plunger 13, the inertial mass of the valve element 17C accompanied with the advancing and retracting motions of the plunger 13 exerts a bad influence on the motion of the relief valve 17, thus making the operation of the relief valve 17 unstable.

Accordingly, in view of the foregoing problems, an object of the present invention is to provide a relief valve built-in hydraulic tensioner having structural features which make the tensioner compact in size, facilitate the boring of the housing, and stabilize the operation of the relief valve.

### SUMMARY OF THE INVENTION

To achieve the foregoing object, the present invention provides a relief valve built-in hydraulic tensioner which comprises: a housing; a plunger slidably fitted in the housing and urged by a spring in a direction to project outward from the housing; an oil chamber formed between the housing and the plunger; a check valve provided between the housing and the oil chamber and operative to permit an oil to flow into the oil chamber from the outside of the housing and block the oil to flow out from the oil chamber; and a relief valve communicating with the oil chamber. The relief valve is comprised of a relief hole formed in the housing, a ring-shaped valve element disposed in the housing at a side opposite to a front end of the plunger, and a relief valve spring urging the ring-shaped valve element in a direction to normally close the relief hole. The central axis of the ring-shaped valve element and the central axis of the relief valve spring urging the ring-shaped valve element are substantially coincident with the respective central axes of the check valve and the plunger.

Since the central axis of the ring-shaped valve element and the central axis of the relief valve spring are substantially coincident on one line with the respective central axes of the check valve and the plunger, the housing can be made compact to thereby enable downsizing of the tensioner as a whoale, and the boring of the housing can easily be achieved.

Further, since the relief valve is installed inside the housing of the tensioner, the ring-shaped valve element can slide smoothly and reliably. The relief valve is, therefore, highly reliable in operation.

In one preferred form of the present invention, the housing has a hole defining a part of the oil chamber, and a cylindrical plug disposed concentrically in the hole with an annular space defined between an inner surface of the hole and an outer surface of the cylindrical plug, the plug being attached to the housing at one end of the hole. The plunger is slidably inserted into the hole from the other end of the hole. The ring-shaped valve element is slidably received between the inner surface of the hole and the outer surface of the plug, and said relief valve spring is disposed in said the annular space.

The hole formed in the housing may be a through-hole having a uniform diameter throughout the length thereof, and the plug may be a flanged plug having an annular flange press-fitted in the through-hole. The housing further has a stop ring attached to the inner surface of the through-hole for restricting movement of the ring-shaped valve element in the direction to close the relief hole.

As an alternative, the hole formed in the housing may be a through-hole having a stepped portion, and the plug may be a flanged plug having an annular flange press-fitted in the through-hole. The the ring-shaped valve element is normally held in abutment with the stepped portion of the stepped through-hole by the force of the relief valve spring.

The hole formed in the housing may be a blind hole closed at the one end thereof and having a small-diameter portion adjacent the closed one end. The plug may be a flange-less plug press-fitted in the small-diameter portion of the blind hole. The housing further has a stop ring attached to the inner surface of the blind hole for restricting movement of the ring-shaped valve element in the direction to close the relief hole.

### BRIEF DESCRIPTION OF THE DRAWINGS

FIG. 1 is a front sectional view of a relief valve built-in hydraulic tensioner according to a first embvodiment of the present invention;

FIG. 2 is a front sectional view illustrating an operational state of the relief valve of the relief valve built-in hydraulic tensioner shown in FIG. 1;

FIG. 3 is a front sectional view of a relief valve built-in hydraulic tensioner according to a second embodiment of the present invention;

FIG. 4 is a front sectional view of a relief valve built-in hydraulic tensioner according to a third embodiment of the present invention;

FIG. 5 is a front sectional view illustrating one example of the conventional relief valve built-in hydraulic tensioner; and

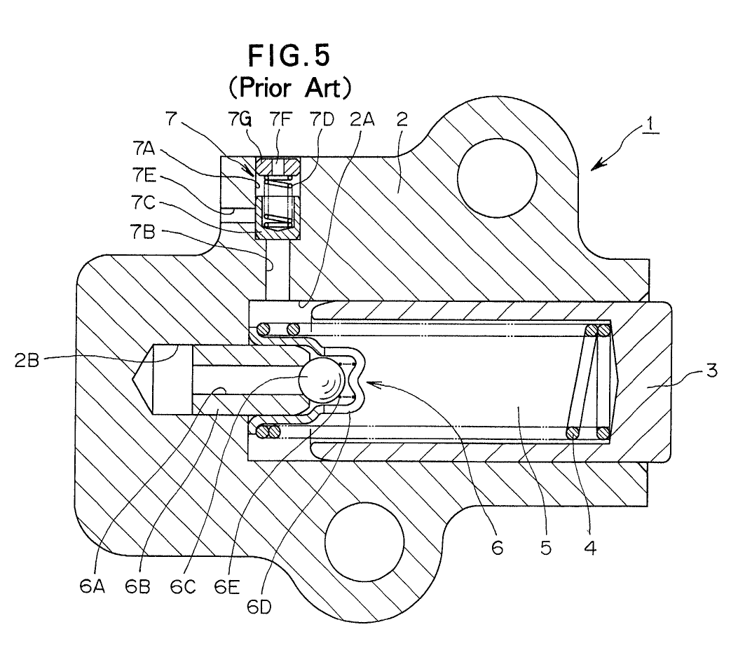

FIG. 6 is a front sectional view illustrating another example of the conventional relief valve built-in hydraulic tensioner.

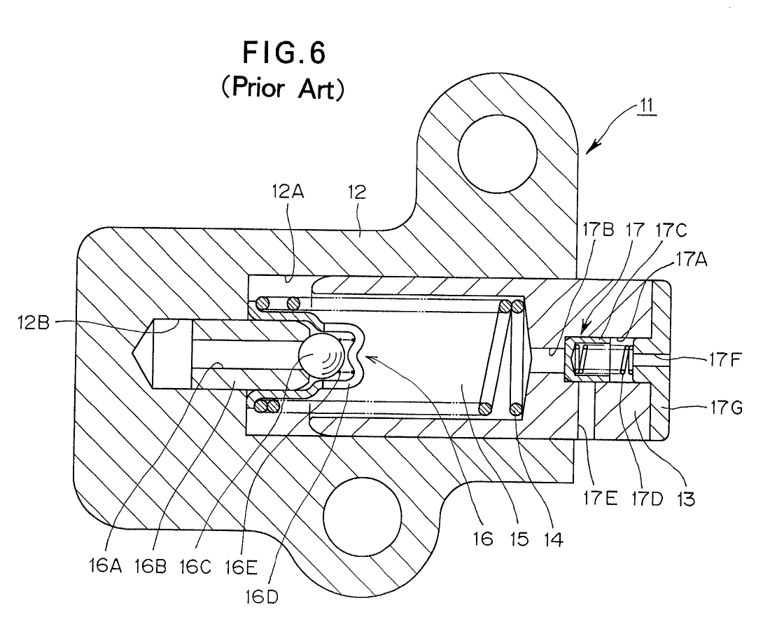

### DETAILED DESCRIPTION OF THE PREFERRED EMBODIMENTS

Certain preferred embodiment of the present invention will be described with reference to the accompanying drawings wherein like reference characters designate like or corresponding parts throughout the several views.

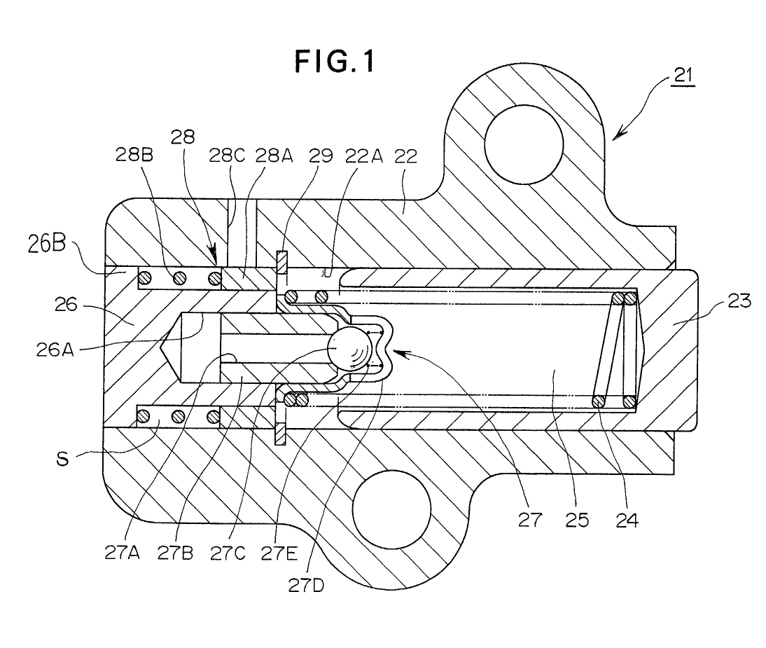

FIG. 1 shows a relief valve built-in hydraulic tensioner according to a first embodiment of the present invention. As shown in this figure, the relief valve built-in hydraulic tensioner 21 includes a housing 22, a plunger 23 slidably fitted in a through-hole 22A formed in the housing 22, a spring 24 that urges the plunger in a direction to project from the housing 22, an oil chamber 25 formed between the housing 22 and the plunger 23, a check valve 27 mounted on a flanged plug 26 press-fitted at an annular flange 26B thereof in the through-hole 22A from an end opposite to the plunger 23, and a relief valve 28 disposed in the housing 22 and located radially outward of the check valve 27. The through-hole 22A has a uniform diameter throughout the length thereof.

The check valve 27 includes a ball seat 27B having an oil path 27A and press-fitted in the blind hole 26A of the flanged plug 26 press fitted in the housing 22, a check ball 27C, a retainer 27D, and a spring 27E. The blind hole 26A of the plug 26 is connected with an oil path (not shown) for supplying an oil from a hydraulic pressure generator or source such as an oil pump (not shown) into the oil chamber 25. The check valve 27 has a function that permits an oil to flow into the chamber 25 and in reverse blocks an oil to flow out from the oil chamber 25.

The relief valve 28 includes a ring-shaped valve element 28A slidably installed between an inner surface of the through-hole 22A formed in the housing 22 and an outer surface of the plug 36, and a relief valve spring 28B that urges the ring-shaped valve element 28A in one direction (rightward direction in FIG. 1) to close a relief hole 28C formed in the housing 22. The spring 28B is disposed in an annular space S defined between the inner surface of the through-hole 22a and the outer surface of the plug 26. Further, a stop ring 29 is attached to the inner surface of the through-hole 22A and disposed radially outward of the check valve 27. The stop ring 29 restricts the movement of the ring-shaped valve element 28A in rightward direction. In operation of the relief valve 28, when the oil pressure inside the oil chamber 25 exceeds a set pressure, the valve element 28A moves backward (leftward direction in FIG. 1) against the force of the spring 28B to allow the oil chamber 25 to communicate with the relief hole 28C, thereby relieving the oil from the oil chamber 25 to lower the oil pressure inside the oil chamber 25.

The relief valve 28 is arranged such that the central axis of the ring-formed valve element 28A and the central axis of the relief valve spring 28B are substantially coincident with the central axes of the check valve 27 and the plunger 23. In other words, the ring-shaped valve element 28A, the relief valve spring 28B, the check valve 27 and the plunger 23 are coaxial with one another.

With the relief valve built-in hydraulic tensioner 21 thus constructed, when a looseness occurs in the chain during the engine being in driving, the plunger 23 advances or moves forward by the force of the spring 24, and at the same time, the check ball 27C is caused to separate from the ball seat 27B to thereby allow an oil to be supplied into the oil chamber 25 by way of the oil path (not shown) formed in the flanged plug 26 in communication with the blind hole 26A and the oil path 27A formed in the ball seat 27B.

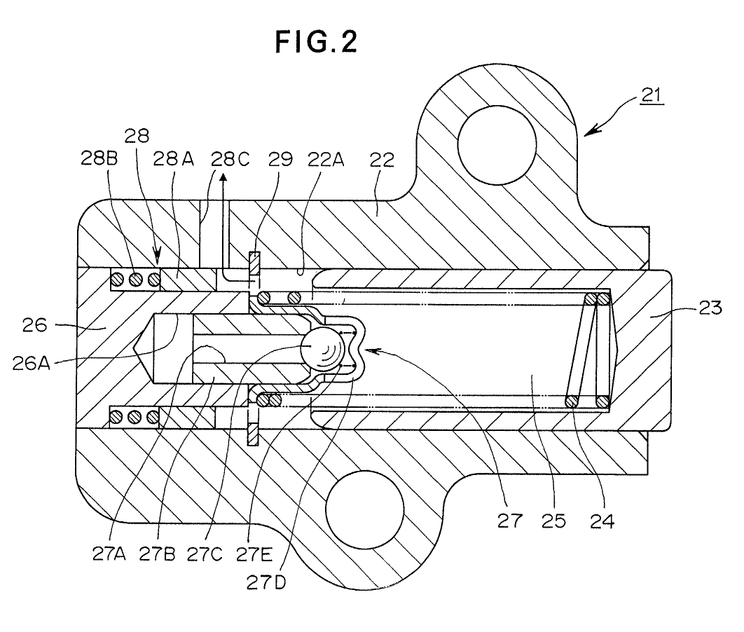

When an excessive tension occurs in the chain, the plunger 23 is subjected to a load or pressure applied from a tensioner lever (not shown) in a direction to move the plunger 23 backward against the force of the spring 24. At this moment, the check valve 27 functions to block the flow-out of an oil in the oil chamber 25, and the oil in the oil chamber 25 being an incompressible fluid deters the plunger 23 from moving backward. However, receiving an oil pressure generated in the oil chamber 25, the ring-shaped valve element 28A of the relief valve 28 slightly slides backward against the force of the relief valve spring 28B to thereby absorbs the excessive tension in the chain. When the load or pressure on the plunger 23 increases further and the ring-shaped valve element 28A of the relief valve 28 retreats further, the oil chamber 25 communicates with the relief hole 28C, whereupon the oil in the oil chamber 25 is allowed to discharge, as indicated by the arrow shown in FIG. 2. Thus, the oil pressure in the oil chamber 25 decreases to thereby relieve the excessive tension of the. With the discharge of the oil, the oil pressure in the oil chamber 25 decreases, so that the ring-shaped valve element 28A moves forward by the force of the spring 28B to close the relief hole 28C, thereby maintaining the set value of the oil pressure in the oil chamber 25. Further, when the oil pressure in the oil chamber 25 decreases excessively, the check valve 27 operates to supply an oil into the oil chamber 25, whereby the oil pressure in the oil chamber 25 returns to a normal value.

In the relief valve built-in hydraulic tensioner 21 of the foregoing embodiment, since the central axis of the ring-shaped valve element 28A and the central axis of the relief valve spring 28B are substantially coincident with the central axes of the check valve 27 and the plunger 23, the housing 22 can be made compact in size, and the boring or drilling of the through-hole 22A formed in the housing 22 can easily be achieved. The tensioner 21 having such compact housing 22 is made compact as a whole.

Further, since the relief valve 28 is installed interiorly of the housing 22 of the tensioner 21, sliding movement of the ring-shaped valve element 28A is highly smooth and reliable. Thus, the relief valve 28 can operate stably.

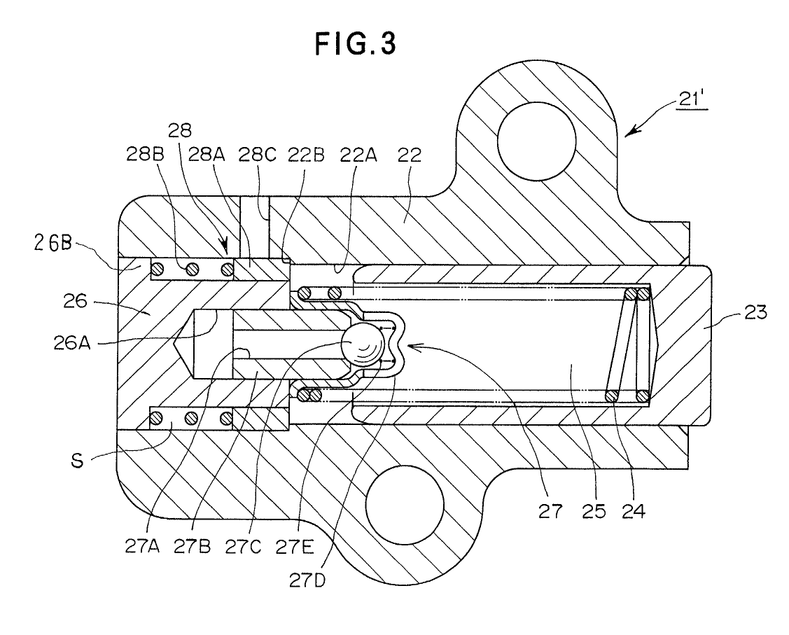

FIG. 3 illustrates a relief valve built-in hydraulic tensioner 21′ according to a second embodiment 2 of the presenrt invention. The tensioner 21′ differs from the tensioner of the first embodiment shown in FIGS. 1 and 2 only in a point described below. In the relief valve built-in hydraulic tensioner 21 of the first embodiment 1 described above with reference to FIGS. 1 and 2, the stop ring 29 attached to the inner surface of the through-hole 22A is used to restrict the movement of the ring-shaped valve element 28A in the rightward direction. However, in the relief valve built-in hydraulic tensioner 21′ of the second embodiment, the through hole 22A formed in the housing 22 is a stepped through-hole, having a step 22B engaged with an end of the ring-shaped valve element 28A to restrict the rightward movement of the valve element 28A.

The relief valve built-in hydraulic tensioner 21′ of the second embodiment 2 has the same function and effect as the relief valve built-in hydraulic tensioner 21 of the first embodiment 1. Accordingly, the same parts are designated by the same reference characters and a further description thereof can, therefore, be omitted.

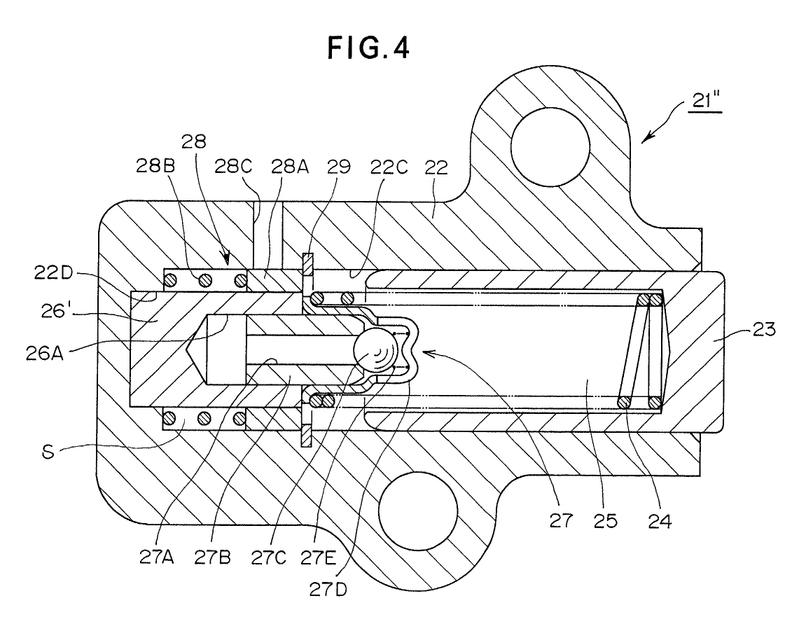

FIG. 4 illustrates a relief valve built-in hydraulic tensioner 21″ of according to a third embodiment of the present invention. The tensioner 21″ differs from the tensioner 21 of the first embodiment shown in FIG. 1 in that the flanged plug 26 press-fitted in the through-hole 22A in the housing 22 of the first embodiment is replaced with a combination of a stepped blind hole 22C formed in the housing 22 and having a small-diameter portion 22D adjacent to the bottom threof, and a flange-less cylindrical plug 26′ press-fitted in the small-diameter portion 22D of the stepped blind hole 22C. The relief valve built-in hydraulic tensioner 21″ of the third embodiment has the same function and effect as the relief valve built-in hydraulic tensioner 21 of the first embodiment shown in FIG. 1. Accordingly, the same parts are designated by the same reference characters, and no further description thereof is needed.

Although the embodiments shown in FIGS. 1-2, FIG. 3 and FIG. 4, respectively, do not have a ratchet mechanism constructed to prevent backward movement of the plunger with a backlash, the invention can also be applied to a relief valve built-in hydraulic tensioner equipped with such latchet mechanism.

As described above, since the central axis of the ring-shaped valve element of the relief valve and the central axis of the relief valve spring that urges the ring-shaped valve element are substantially coincident with the central axes of the check valve and the plunger, the housing can be made compact in size and thus downsizes the tensioner as a whole, and the boring or drilling of the housing can easily be achieved.

Further, since the relief valve is installed inside the housing of the tensioner, sliding movement of the ring-shaped valve element can be performed smoothly and reliably. Thus, the relief valve is highly reliable in operation.

Obviously, various minor changes and modifications of the present invention are possible in the light of the above teaching. It is therefore to be understood that within the scope of the appended claims, the present invention may be practiced otherwise than as specifically described.

What is claimed is:

1. A relief valve built-in hydraulic tensioner comprising:
a housing;
a plunger slidably fitted in the housing and urged by a spring in a direction to project outward from the housing;
an oil chamber formed between the housing and the plunger;
a check valve provided between the housing and the oil chamber and operative to permit an oil to flow into the oil chamber from the outside of the housing and block the oil to flow out from the oil chamber;
a relief valve communicating with the oil chamber;
the relief valve being comprised of a relief hole formed in the housing, a ring-shaped valve element disposed in the housing at a side opposite to a front end of the plunger, and a relief valve spring urging the ring-shaped valve element in a direction to normally close the relief hole;
the central axis of the ring-shaped valve element and the central axis of the relief valve spring urging the ring-shaped valve element being substantially coincident with the respective central axes of the check valve and the plunger.

2. The relief valve built-in hydraulic tensioner according to claim 1, wherein the housing has a hole defining a part of the oil chamber, and a cylindrical plug disposed concentrically in the hole with an annular space defined between an inner surface of the hole and an outer surface of the cylindrical plug, the plug being attached to the housing at one end of the hole, the plunger bing slidably inserted into the hole from the other end of the hole, the ring-shaped valve element being slidably received between the inner surface of the hole and the outer surface of the plug, and said relief valve spring being disposed in said the annular space.

3. The relief valve built-in hydraulic tensioner according to claim 2, wherein the hole is a through-hole having a uniform diameter throughout the length thereof, the plug is a flanged plug having an annular flange press-fitted in the through-hole, and the housing further has a stop ring attached to the inner surface of the through-hole for restricting movement of the ring-shaped valve element in the direction to close the relief hole.

4. The relief valve built-in hydraulic tensioner according to claim 2, wherein the hole is a stepped through-hole having a stepped portion, the plug is a flanged plug having an annular flange press-fitted in the through-hole, and the ring-shaped valve element is normally held in abutment with the stepped portion of the stepped through-hole by the force of the relief valve spring.

5. The relief valve built-in hydraulic tensioner according to claim 2, wherein the hole is a blind hole closed at the one end thereof and having a small-diameter portion adjacent the closed one end, the plug is a flange-less plug press-fitted in the small-diameter portion of the blind hole, and the housing further has a stop ring attached to the inner surface of the blind hole for restricting movement of the ring-shaped valve element in the direction to close the relief hole.
